(19) United States
(12) Patent Application Publication
(10) Pub. No.: US 2017/0130171 A1
(43) Pub. Date: May 11, 2017

(54) LOW FOAMING MULTI ENZYMATIC CLEANER

(71) Applicant: 3M INNOVATIVE PROPERTIES COMPANY, St. Paul, MN (US)

(72) Inventors: RAJENDRA H. VISHNUMURTHY, BANGALORE (IN); VISHALKUMAR Y. JOSHI, AHMEDABAD (IN)

(21) Appl. No.: 15/315,953

(22) PCT Filed: Jun. 22, 2015
(86) PCT No.: PCT/US15/36966

§ 371 Date: Dec. 2, 2016

(30) Foreign Application Priority Data
Jun. 24, 2014 (IN) 3067/CHE/2014

(51) Int. Cl. C11D 3/386; C11D 3/37; C11D 11/00; C11D 1/94

(52) U.S. Cl. CPC C11D 3/38663; C11D 1/94; C11D 3/3765; C11D 3/3776; C11D 11/0023

(57) ABSTRACT

The present invention relates to a cleaning composition for cleaning medical instruments. The cleaning composition of the invention comprises: an enzyme activity protector complex; an enzyme system; one or more controlling polymers; surfactants; organic solvent; and additives selected from chelating agents, wetting agents, preservatives and water. In particular, the cleaning composition of the invention is a low foaming, multi enzymatic cleaner having excellent efficacy for enzymatic cleaning, hard water scale inhibition and rust inhibition due to scaling. The composition further provides shine with superior wetting and cleaning performance. The invention also relates to a process for preparing a cleaning composition and a method of cleaning medical instruments employing the cleaning composition of the present invention.

### CROSS REFERENCE TO RELATED APPLICATIONS

This application claims priority to India Patent Application No. 3067/CHE/2014, filed Jun. 24, 2014, the disclosure of which is incorporated by reference in its entirety.

### FIELD

The present disclosure relates to cleaning compositions for cleaning medical instruments. In some embodiments, the cleaning compositions are low foaming, multi enzymatic cleaners having excellent efficacy for enzymatic cleaning. In some embodiments, the compositions inhibit hard water scale deposits and rusting due to such scaling. In some embodiments, the compositions further provide shine with superior wetting and cleaning performance.

### BACKGROUND

It is a common practice to clean medical instruments after use with one patient and prior to treatment of another. To minimize the possibility of cross infection, instruments used with one patient are desirably cleaned separately from those used with another. The cleaned instruments are thoroughly rinsed and subjected to further disinfection or sterilization procedures. The cleaning is usually done by first scrubbing to remove blood, tissue, loose proteinaceous material and other soils, and then soaking for a predetermined period in an enzyme preparation adapted to further digest or loosen any proteinaceous material remaining on the instrument surface. Typical cleaning solutions employed for this purpose comprise one or more proteolytic enzymes along with surfactants and carriers. Care must be taken such that the cleaning solutions so formulated exhibit low foaming capability while at the same time are stable at high pH and temperature. Further, cleaning formulations comprising enzymes and surfactants consist generally of a concentrate. The concentrate is generally diluted to a working strength prior to use. Again, it has to be borne in mind that such dilutions do not alter the stability and cleaning efficacy of the formulation.

Most of the hospitals around the world are witnessing a shift in trend from manual to automatic washing to clean medical or surgical instruments. Typically, automatic washing happens in a washer/disinfector or an ultrasonic washer at 90° C. or 40° C.-70° C., respectively. Even though hospitals may be required to use high quality Reverse Osmosis water as per the guidelines, there are situations wherein many hospitals tend to use hard water with considerably high levels of hardness due to the large volume of appliances for cleaning. This results in scale deposits on the internal walls of the washer. Consequently, the need to de-scale these equipment operating at high temperatures is continuously increasing as this seems to be a real issue across the hospitals globally. Further, the de-scaling activity is done only as part of the maintenance when the equipment is shut down and not available for cleaning the surgical instruments, typically once every few months or so. This typically results in medical equipment containing hard water scale with strong deposition which gives rise to corrosion and eventually a low shine.

A wide variety of cleaning compositions are known in the art. For instance, a process and composition for cleaning medical instruments are disclosed in WO 0176647 wherein the composition contains an enzyme, a quat biocide, and an activity protector. Further enzyme containing cleaning compositions are disclosed in GB 2360041, WO 200318734 and WO 200809053. The compositions disclosed in these documents comprise in general, an enzyme system, surfactant or hydrotrope, and aqueous carrier.

However, none of the enzymatic cleaners known in the art are able to effectively inhibit hard water scale and corrosion. This is because hard water scale inhibitors and corrosion preventers are highly acidic in nature, which would deactivate the enzymes rapidly. Moreover surfactants or polymers tend to react rapidly either with activity protector or with enzymes and destabilize the entire system.

In view of the aforesaid, it is clear that there is a crucial need to formulate liquid compositions for cleaning medical appliances which can effectively breakdown macromolecules such as proteinaceous material, starches and fats into small molecules from the surface and at the same time inhibit hard water scale deposition and corrosion. In some embodiments, such compositions should exhibit low foam characteristics and maintain shine of the appliance.

### Object

Accordingly, in one embodiment, the present disclosure provides cleaning compositions for cleaning medical instruments having excellent efficacy for enzymatic cleaning.

In some embodiments, the cleaning compositions will inhibit hard water scale and strong deposition which will otherwise results in rust formation.

In some embodiments, the cleaning compositions are low foaming in nature, with superior wetting and cleaning performance.

In some embodiments, the cleaning compositions will maintain enhanced shine of the instrument.

### BRIEF DESCRIPTION OF THE DRAWINGS

Aspects of some embodiments of the present disclosure are illustrated in the accompanying drawings:

FIG. 1A-1D shows a comparison of performance of hard water scale cleaning on stainless steel plates by exemplary compositions of the present disclosure over commercially known products.

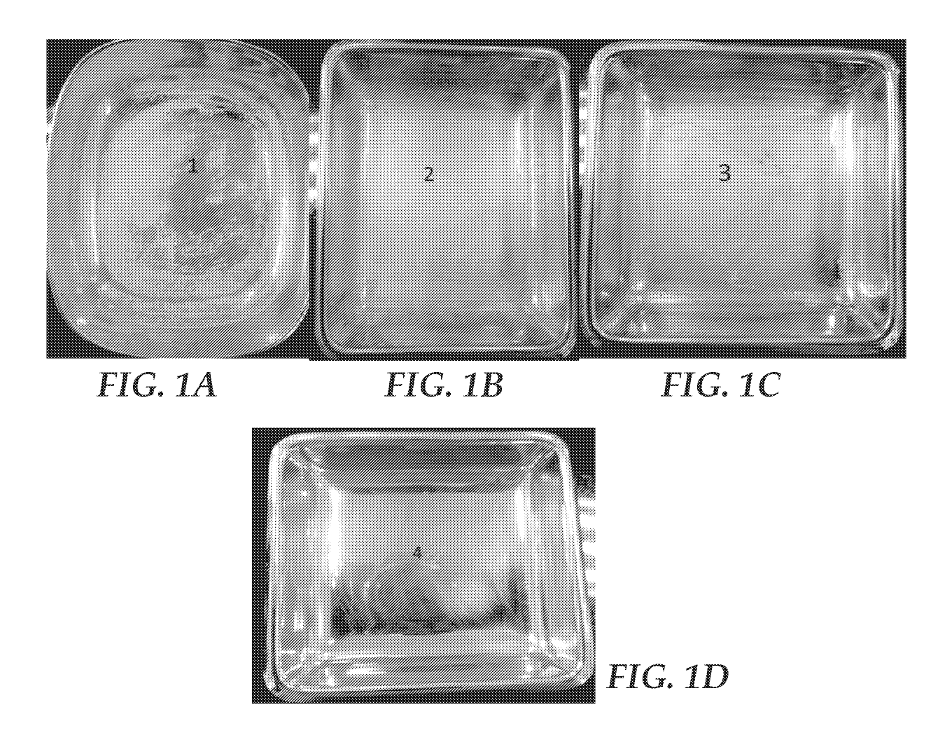

### SUMMARY

The present disclosure relates to a cleaning composition comprising: at least one enzyme activity protector complex; an enzyme system; one or more controlling polymers comprising a plurality of metal ion complexing groups, the complexing groups selected from the group consisting of carboxylic acid groups, pyrrolidone groups, and combinations thereof; at least two surfactants, wherein at least one surfactant is an ionic surfactant and at least one surfactant is an amphoteric surfactant; surfactants; organic solvent, and water. In some embodiments, the composition may include one or more additives such as chelating agents, wetting agents, and preservatives.

The disclosure also relates to a process for preparing a cleaning composition comprising: (a) forming a stable micelle complex comprising at least one enzyme activator protector complex, an organic solvent, and at least one surfactant; (b) forming a ph-adjusted controlling polymer by increasing the pH of a controlling polymer to at least 10, in some embodiments, at least 12; (c) forming an intermediate formulation by adding the ph-adjusted controlling polymer to said stable micelle complex; (d) adjusting the pH of the resulting intermediate formulation to neutral medium; and (e) adding an enzyme system to form a stable cleaning composition.

The present disclosure further relates to a method of cleaning medical instruments comprising the step of treating said instrument with a cleaning composition according to any of the various embodiments of the present disclosure.

### DETAILED DESCRIPTION

The objects and many of the expected advantages of the present disclosure will be readily appreciated as the same becomes better understood by reference to the following detailed description. The compositions of the disclosure are particularly useful for cleaning medical instruments.

Unless defined otherwise, all technical and scientific terms used herein have the same meaning as commonly understood by one of ordinary skill in the art to which the invention pertains. It is also to be understood that the terminology used herein is for the purpose of describing particular embodiments of the invention only, and is not intended to limit the scope of the invention in any manner.

It must be noted that, as used in this specification and the appended claims, the singular forms “a,” “an” and “the” include plural referents unless the content clearly dictates otherwise. Thus, for example, reference to a “solvent” may include two or more such solvents.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

As used herein, the terms “comprising” “including,” “having,” “containing,” “involving,” and the like are to be understood to be open-ended, i.e., to mean including but not limited to.

The compositions of the present disclosure comprise: at least one enzyme activity protector complex; an enzyme system; one or more controlling polymers; surfactants; organic solvent; water; and optionally additives selected from chelating agents, wetting agents, and preservatives.

The term “enzyme activity protector complex” is herein used to refer to a complex comprising a boron compound and an adjuvant such as a polyhydroxy compound or a silane polyether compound. It is known that enzymes may become unstable during storage, or in the presence of other enzymes or components in a composition. Thus, in order to protect or prevent the enzymes from interacting with other components, enzyme stabilizing systems are usually developed. In some embodiments of the present disclosure, the enzyme activity protector complex is effective in: (a) better spreading on the target surface; (b) improved film forming capability; and (c) optimized complex formation reversible on dilution. The amount of the enzyme activity protector complex present in the formulation is chosen such that the above said characteristics are achieved in an appreciable manner. Typically, the enzyme activity protector complex is present in an amount of about 2% to about 8% by weight of the composition.

In a preferred embodiment, the enzyme activity protector complex comprises a boron compound and an alkyl ether terminated silane polyether having the formula:

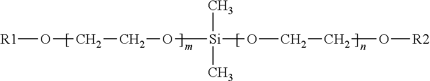

wherein m and n are independently selected integers and range from 8 to 30, and R1 and R2 are linear or branched alkyl groups. In some embodiments, m and n are at least 12. In some embodiments, m and n are no greater than 24, e.g., no greater than 20. In some embodiments, m and n are at least 16 and no greater than 20, e.g., in some embodiments, m and n are 18, i.e., the silane polyether is a bis-(PEG-18 alkyl ether) dimethyl silane. In some embodiments, R1 and R2 have 1 to 6 carbon atoms, e.g., 1-4 carbon atoms. In some embodiments, R1 and R2 are methyl groups. In some embodiments, the silane polyether is bis-(PEG-18 methyl ether) dimethyl silane.

The boron compound in the enzyme activity protector complex may be selected from the group consisting of borax, boric acid and combinations thereof. In some embodiments, the silane polyether may be combined with borax (also referred to as sodium borate, sodium tetraborate, and disodium tetraborate) to form a complex.

In some embodiments, the molar ratio of the boron compound to the silane polyether is from 90:10 to 30:70. In some embodiments, the molar ratio of the boron compound to the silane polyether is from 70:30 to 40:60.

In another preferred embodiment, the enzyme activity protector complex comprises a boron compound and a polyhydroxy containing compound. Typical polyhydroxy compounds employed in the present disclosure include but are not limited to sugars, sugar alcohols, sugar acids, glycerol, uronic acid, and combinations thereof. In particular, complexes of borax or boric acid with glycerol may be used to stabilize enzymes in multi-component compositions.

The amount of polyhydroxy compound in the composition of the present invention is such that they form a suitable reversible complex to stabilize the enzyme. Typically, the molar ratio of the boron compound to the polyhydroxy compound is from 80:20 to 30:70. In some embodiments, the molar ratio of the boron compound to the polyhydroxy compound is from 60:40 to 40:60.

The term “enzyme system” used herein refers to either one enzyme or more than one enzyme in combination with each other. In the present disclosure, the cleaning composition comprises one or more enzymes selected from amylases, cellulases, lipases, proteases, and combinations thereof. Enzymes present in cleaning compositions play a vital role in cleaning instruments that contain biological contaminants. The enzymes possess the ability to breakdown complex biological macromolecules to simpler molecules. For instance, proteases are useful in breaking down protein, amylases for breaking down starch, and lipases for breaking down lipid molecules. The amount of enzyme present in the composition depends on the desired concentration of the active enzyme in the final diluted product. In some embodiments, the enzyme system is present in an amount of about 0.5% to about 15% by weight of the total composition.

It is known in the art to use inorganic acids for inhibiting hard water scale formation; however these acids are suitable only at lower pH. Also, when enzymes are present in the cleaning composition, it is found that these inorganic acids showed negative effects like enzyme degradation, precipitation etc.

In contrast, the present inventors have discovered that certain organic polymers, i.e., “controlling polymers,” may be used to inhibit hard water scale deposits. “Controlling polymer” refers to one or more polymers which are employed for the purpose of controlling or inhibiting hard water scale formation. It is believed that the mechanism by which the inhibition of hard water scale is achieved is by means of chelation of the controlling polymers with heavy metals such as magnesium and calcium present in hard water that are responsible for the scale formation.

In some embodiments, the controlling polymer comprises carboxylic acid chelating groups. In some embodiments, the carboxylic acid groups are based on maleic acid, acrylic acid, or combinations thereof. In some embodiments, the chelating groups comprise pyrrolidone groups, e.g., pyrrolidone groups derived from vinyl pyrrolidone. In some embodiments, the controlling polymer is preferably present in an amount of about 0.5% to about 10% by weight of the total composition.

The use of the controlling polymers in the compositions of the present disclosure has the advantage of working in a broader pH range than compositions relying on inorganic acids.

Surfactants are known to assist in cleaning thereby providing enhanced cleaning efficacy. However due care has to be taken regarding the nature and amount of the surfactant, since they tend to possess foaming characteristics. Excessive foaming is undesired in cleaning compositions especially in the medical field since this leads to unwanted blockage in the water jets and washing liquor circulation systems in automated washers. Further, excess foam may lead to reduced cleaning efficacy.

A wide variety of surfactants are available including ionic (anionic and cationic) surfactants, non-ionic surfactants, and amphoteric surfactants. Surprisingly, the present inventors discovered that the use of single surfactant did not lead to acceptable results. Thus, the cleaning compositions of the present disclosure comprise at least two surfactants. In particular, the compositions comprise at least one ionic surfactant and at least one amphoteric surfactant. In some embodiments, at least one ionic surfactant is an anionic surfactant. The amount of surfactants is chosen carefully so as to provide sufficient detergency for removal of biological contaminants Typically, the total amount of surfactant in the cleaning composition is about 5% to about 27% by weight of the total composition.

The composition of the present disclosure comprises an organic carrier or co-solvent. Suitable co-solvents are water soluble and compatible with other ingredients of the composition. Such co-solvents are employed to enhance stability and solubility of the composition. In some embodiments, the organic solvent is a glycol, e.g., in some embodiments, the organic solvent is ethylene glycol. In some embodiments, the organic solvent is a glycol ether, e.g., an alkyl glycol ether. For example, in some embodiments, the organic solvent is ethylene glycol, dipropylene glycol methyl ether and combinations thereof.

The cleaning compositions of the present disclosure also include water. The water used is preferably distilled or de-ionized water. Water is added in “quantum sufficient” (QS) to the composition. The compositions of the present disclosure may be the “concentrated” form of the composition which may be diluted to a workable dilution range using water. In the present disclosure, the pH of the concentrated composition increases by at least 1 upon dilution with 300 parts water per 1 part of the composition.

The term “additives” herein refers to ingredients which are added usually in small amounts, yet may provide a significant effect on the product. Generally, additives do not significantly alter the percentages of individual components in a formulation. Additives in the present invention include but are not limited to ingredients such as chelating agents, wetting agents, and preservatives. Chelating agents, wetting agents and preservatives employed are those that are known to a person skilled in art. However the amount of these ingredients present in the composition is particularly selected to yield a cleaning composition with overall desired efficacy.

Another embodiment of the disclosure relates to a process for preparing a cleaning composition. The process comprising: (a) forming a stable micelle complex comprising at least one enzyme activator protector complex, an organic solvent, and at least one surfactant; (b) forming a ph-adjusted controlling polymer by increasing the pH of a controlling polymer to at least 10, in some embodiments, at least 12; (c) forming an intermediate formulation by adding the ph-adjusted controlling polymer to said stable micelle complex; (d) adjusting the pH of the resulting intermediate formulation to neutral medium; and (e) adding an enzyme system to form a stable cleaning composition. The term “neutral medium” herein refers to a pH range of about 6.5 to about 7.5, most preferably 6.9 to 7.3. The term alkaline medium refers to a pH range of about 10 to 14.

The enzyme activity protector complexes are prepared by known methods. For instance, preferred activity protector complexes are prepared in a manner wherein both a boron compound and adjuvant (polyhydroxy or a silane polyether compound) are dissolved in water at suitable temperature; stirred at room temperature and the pH adjusted to 6.8 to 7.0. In some embodiments, the boron compound is initially dissolved at a temperature above room temperature until the solution is clear; followed by the addition of the adjuvant (polyhydroxy or a silane polyether compound) at room temperature with stirring and finally adjusting the pH to the desired range.

In the process of the present disclosure it is believed that the addition of surfactants to the enzyme activity protector complex enable the formation of a suitable micelle complex. This micelle forms as a barrier between the controlling polymer and the borax complex thereby preventing the undesired interaction of the controlling polymer with that of the borax complex.

A further embodiment of the present disclosure relates to a method of cleaning medical instruments comprising the step of treating said instrument with a cleaning composition of the disclosure.

The identity of the specific constituents employed in exemplary cleaning compositions of the present disclosure is listed in Table 1.

TABLE 1
Components used to prepare the examples.

| Constituent | | Trade Name/Common Name | I.D. | Manufacturer |
|---|---|---|---|---|
| Enzyme | Boron compound | Borax | | S.D. Fine |
| Activity | Polyhydroxy | Glycerol | | S.D. Fine |
| Protector | compound | | | |
| Complex | alkyl ether | Bis-PEG-18 methyl | | Dow corning |
| | terminated silane | ether dimethyl silane | | |
| | polyether | (DC 2501) | | |
| Enzyme | Protease | Savinase Ultra 16XL | Enz-P | Novozyme |
| system | Lipase | Lipolase 100L | Enz-L | Novozyme |
| | Carbohydrate enzyme | Carezyme 4500L | Enz-C | Novozyme |
| | Amylase | Termamyl 300L | Enz-A | Novozyme |
| Controlling | low molecular weight | Maxinol PM 200 | CP-1 | Aqua pharma Ltd |
| Polymer | maleic homo polymer | | | |
| | low molecular weight | Maxinol 5420 | CP-2 | Aqua pharma Ltd |
| | carboxylate polymer | | | |
| | PVP based polymer | Plasdone K 29 | CP-3 | ISP |
| Surfactant/ | Hydrotrope- | Sodium xylene | Surf-I-1 | S.D. fine |
| Hydrotrope | Anionic | sulfonate (SXS) | | |
| | Anionic | Coco DMA | Surf-I-2 | S.D. fine |
| | Non-ionic | Surfynol 465 | Surf-NI-1 | Air products |
| | Glucose based | Alkyl poly glucoside | Surf-NI-2 | Cognis |
| | surfactant-Non ionic | | | |
| | Non ionic | Teric 168 | Surf-NI-3 | Huntsman Corporation |
| | Non Ionic | Surfynol 465 | Surf-NI-4 | Air products |
| | Non ionic | Tween 60 | Surf-NI-5 | Croda |
| | Non ionic | Tween 80 | Surf-NI-6 | Croda |
| | Non ionic | Triton 100 | Surf-NI-7 | S.D. fine |
| | Hydrotrope- | Tomamine A-400 | Surf-Amp-1 | Air products |
| | Amphoteric | | | |
| | Amphoteric | Amphoteric L | Surf-Amp-2 | Air products |
| Organic | Organic Solvent | Ethylene glycol | EthGly | S.D. fine |
| Solvent | Organic Solvent | Dipropylene glycol | DPGME | S.D. fineS. D. fine |
| | | methyl ether | | |
| Additives | Chelating salt | EDTA-disodium | Add-1 | ISP |
| | Wetting agent | Surfadone LP | Add-2 | S.D. fine |
| | Preservative | Kathon WT | Add-3 | Dow chemical |

The exemplary cleaning compositions of the present disclosure thus obtained by the above mentioned process were subjected to various tests:

(1) Stability, Appearance and pH. The stability and appearance of the cleaning compositions thus formed are checked visually. Unless otherwise mentioned, in the examples illustrated below, the following letters are used to indicate the property of the formulation: S=Stable; NS=Not stable; C=clear; NC=not clear.

The pH of the composition is measured using a pH meter which is standardized with standard buffers.

(2) Tendency to Foam. Tendency to foam was checked for cleaning compositions at 3000 rpm and 1:100 dilution using centrifuge.

(3) Scale removal. Hard water scale was prepared using MgCl2, CaCl2 and NaHCO3. In study, first MgCl2 and CaCl2 were dissolved in water to have solution-A. NaHCO3 was dissolved in fresh water and noted as solution-B. In a beaker, 1 ml of test solution, 12 ml of solution A, and 16 ml solution B are added and finally made up to a volume of 100 ml using water. The solution is then evaporated on the desired surface to have hard water scale. Following cleaing with the exemplary compositions, the removal of the hard water scale was evaluated, with “Yes” indicating the scale was removed and “No” indicating that insufficient scale removal was obtained.

(4) Enzyme Activity. Enzyme activity tests were conducted as per Novo Nordisk standard method for enzyme analysis and available as Ref No. B 863b-GB, U.S. Pat. No. 6,939,836B2.

(5) Blood removal. Cleaning performance was checked on BROWNE STF Load Check Strips at 45° C. with 1:100 dilutions. The time taken for complete removal of the blood spots from the strips was measured.

The present invention is illustrated by the following examples, but should not be construed to be limited thereto. The “%” herein in the specification refers to % by weight unless specified otherwise.

### EXAMPLES

### Comparative Example Set A

Preparation of Enzyme Activity Protector ComplexA borax-polyhydroxy activity protector was prepared using borax and glycerol. Both borax and glycerol were dissolved in water at 45° C. for 30 minutes followed by stirring at room temperature for the next 15 minutes. The pH was adjusted to around 6.8 to 7.0 using hydrochloric acid. Enzymes were finally added and stirred for 15 min to produce a clear storage stable formulation. The composition of the borax-polyhydroxy activity protector and associated enzymes are summarized in Table 2A, and is identified as Reference Example 1.

A borax-silane polyether activity protector was prepared as follows. Borax was first dissolved in water at 45° C. for 15 minutes. After having a clear solution, the temperature was brought to 35° C. and Bis-PEG-18 methyl ether dimethyl silane was added and stirred for 30 min. The pH was adjusted to around 6.8 to 7.0 using hydrochloric acid and enzymes were added followed by stirring for 15 minutes to produce a clear storage stable formulation. The composition of the borax-silane polyether activity protector and associated enzymes are summarized in Table 2A, and is identified as Reference Example 2.

Table 2B shows results obtained with compositions prepared using the two different enzyme activity protectors, both of which can effectively bind multiple enzymes and release them appropriately on dilution.

TABLE 2A
Compositions with enzymes and an activity protector (wt. %).

| Ex. | Borax | Glycerol | DC 2501 | Enz-P | Enz-L | Enz-C | Enz-A | Water |
|---|---|---|---|---|---|---|---|---|
| Ref-1 | 3 | 3 | — | 10 | 0.22 | 0.11 | 1.5 | Q.S. |
| Ref-2 | 3 | — | 1 | 10 | 0.22 | 0.11 | 1.5 | Q.S. |

TABLE 2B
Results

| | | | | Tendency | Hard water | Enzyme activity |
|---|---|---|---|---|---|---|
| Ex. | Stability | Appearance | pH | to foam | scale removal | (after 1 month at 52° C.) |
| Ref-1 | S | C | 6.5 | No | No | Protease - 0.314 AU/ml |
| | | | | | | Amylase - 5.603 KNU/ml |
| Ref-2 | S | C | 6.8 | No | No | Protease - 0.307 AU/ml |
| | | | | | | Amylase - 6.655 KNU/ml |

### Comparative Example—Set B: Effect of Adding a Single Surfactant to Reference Example-1

The effect of adding a single surfactant or hydrotrope to a composition containing enzymes stabilized with a borax-glycerol complex was studied. Each of the compositions was based on the enzyme-containing composition of Reference Example 1. The amount of water was adjusted to bring the total to 100% by weight. The results are shown in Table 3. None of these compositions (Comparative Examples 3-12) removed the hard water scale deposits.

TABLE 3
Addition of a single surfactant to the composition of Reference Example 1.

| | | Comparative Example Number | | | | | | | | | |
|---|---|---|---|---|---|---|---|---|---|---|---|
| | | 3 | 4 | 5 | 6 | 7 | 8 | 9 | 10 | 11 | 12 |
| Surfactant | I.D. | Amp-2 | NI-4 | NI-3 | I-1 | NI-6 | NI-5 | Amp-1 | NI-7 | I-2 | NI-2 |
| | Wt. % | 7 | 7 | 7 | 7 | 5 | 5 | 7 | 5 | 5 | 5 |

| | | | | | | | | | | |
|---|---|---|---|---|---|---|---|---|---|---|
| Stability at RT | S | S | S | S | S | S | S | S | S | S |
| Stability at 45° C. | S | S | S | S | NS | NS | S | NS | NS | S |
| for 1 month | | | | | | | | | | |
| Appearance | C | C | C | C | NC | NC | C | C | C | C |
| pH | 6.8 | 6.7 | 6.8 | 6.5 | 6.9 | 6.9 | 6.8 | 6.6 | 6.7 | 6.5 |
| Tendency to foam | Yes | No | Yes | No | Yes | Yes | No | Yes | Yes | Yes |
| Hard water | No | No | No | No | No | No | No | No | No | No |
| scale removal | | | | | | | | | | |

### Comparative Example Set C: Effect of Adding a Single Surfactant to Reference Example-2

The effect of adding a single surfactant or hydrotrope to a composition containing enzymes stabilized a borax-silicone polyether complex (Reference Example 2) was studied. Each of the compositions was based on the enzyme-containing composition of Reference Example 2. The amount of water was adjusted to bring the total to 100% by weight. The results are shown in Table 4. It is clear that none of these compositions (Comparative Examples 13-22) showed removal of hard water scale deposits.

TABLE 4
Addition of a single surfactant to the composition of Reference Example 2.

| | | Comparative Example No | | | | | | | | | |
|---|---|---|---|---|---|---|---|---|---|---|---|
| | | 13 | 14 | 15 | 16 | 17 | 18 | 19 | 20 | 21 | 22 |
| Surfactant | I.D. | Amp-2 | NI-4 | NI-3 | I-1 | NI-6 | NI-5 | Amp-1 | NI-7 | I-2 | NI-2 |
| | Wt. % | 7 | 7 | 7 | 7 | 5 | 5 | 7 | 5 | 5 | 5 |

| | | | | | | | | | | |
|---|---|---|---|---|---|---|---|---|---|---|
| Stability at RT | S | S | S | S | S | S | S | S | S | S |
| Stability at 45° C. | S | S | S | S | NS | NS | S | NS | NS | S |
| for 1 month | | | | | | | | | | |
| Appearance | C | C | C | C | C | NC | C | NC | C | C |
| pH | 6.8 | 6.7 | 6.8 | 6.5 | 6.9 | 6.9 | 6.8 | 6.6 | 6.7 | 6.5 |
| Tendency to foam | Yes | No | Yes | No | Yes | Yes | No | Yes | Yes | Yes |
| Hard water scale | No | No | No | No | No | No | No | No | No | No |
| removal | | | | | | | | | | |

### Comparative Example Set D

Effect of adding a combination of surfactants/hydrotropes to Reference Examples 1 and 2. Table 5 shows the effect of adding a combination of surfactants or hydrotropes to the compositions of Reference Examples 1 and 2. Foaming behavior was checked for each composition and found suitable when hydrotropes or non foaming surfactants were used. Overall Surf-NI-1 (between 2 to 7%), Surf-Amp-1 (between 1 to 12%) and combination thereof showed acceptable stability, and less foaming as individual as well as mixed systems. However, none of the compositions removed hard water scale deposits.

TABLE 5
Addition of a multiple surfactants to Reference Examples 1 and 2.

| | Comparative Example Number | | | | | | | |
|---|---|---|---|---|---|---|---|---|
| | 23 | 24 | 25 | 26 | 27 | 28 | 29 | 30 |
| Reference Sample | REF-1 | REF-1 | REF-1 | REF-1 | REF-2 | REF-2 | REF-2 | REF-2 |
| Surf-NI-1 | 2 | 5 | 5 | — | 2 | 5 | 5 | — |
| Surf-NI-3 | 1 | — | 1 | 1 | 1 | — | 1 | 1 |
| Surf-Amp-1 | 5 | 1 | — | 5 | 5 | 1 | — | 5 |
| Stability at RT | S | S | S | S | S | S | S | S |
| Stability at 45° C. | S | S | S | S | S | S | S | S |
| Appearance | C | C | C | C | C | C | C | C |
| Tendency to foam | Yes | No | No | Yes | Yes | No | No | Yes |
| Hard water scale | No | No | No | No | No | No | No | No |
| Removal | | | | | | | | |

### Comparative Example Set E: Effect of Adding Controlling Polymers at Acidic pH

Table 6 (Comparative Example Nos. 31-47), illustrate the formulations using CP-1 (Maxinol PM 200), CP-2 (Maxinol 5420) and CP-3 (Plasdone 29) as controlling polymers in concentrations ranging from 0.5 to 2%. The controlling polymers were added to Reference Examples Ref-1 and Ref-2 at acidic pH (1.9 to 3.2). Water was added to bring the total to 100% by weight. At acidic pH, the polymers showed strong chelating behavior and precipitated out quickly from system. To increase the stability of the compositions various concentrations of surfactants were tried, however none of the approaches showed good stability.

TABLE 6

| | Comparative Example No | | | | | | | | | | | | | | | | |
|---|---|---|---|---|---|---|---|---|---|---|---|---|---|---|---|---|---|
| | 31 | 32 | 33 | 34 | 35 | 36 | 37 | 38 | 39 | 40 | 41 | 42 | 43 | 44 | 45 | 46 | 47 |
| Reference Sample | Ref-2 | Ref-1 | Ref-2 | Ref-1 | Ref-2 | Ref-1 | Ref-2 | Ref-1 | Ref-2 | Ref-2 | Ref-2 | Ref-2 | Ref-1 | Ref-1 | Ref-1 | Ref-1 | Ref-1 |
| Surf-NI-1 | 1 | 1 | — | — | — | — | — | — | — | — | — | — | — | — | — | — | — |
| Surf-NI-3 | 4 | — | — | — | — | — | — | — | — | — | 7 | 7 | 7 | — | — | — | — |
| Surf-Amp-1 | 7 | 7 | 7 | 7 | 7 | 7 | 7 | 7 | 7 | 7 | 2 | — | 2 | 7 | 7 | 7 | 7 |
| CP-1 | 0.5 | 0.5 | 1 | 1 | 2 | 2 | — | — | 2 | — | — | 2 | — | — | 2 | — | 1 |
| CP-2 | — | — | — | — | — | — | — | 0.5 | — | 2 | — | — | — | 2 | — | 2 | — |
| CP-3 | — | — | — | — | — | — | 0.5 | — | — | — | — | — | — | — | — | — | — |
| Surfadone LP 300 | 0.03 | 0.03 | — | — | — | — | — | — | — | — | — | — | — | — | — | — | — |
| Kathon WT | 1.5 | 1.5 | 1.5 | 1.5 | 1.5 | 1.5 | 1.5 | 1.5 | 1.5 | 1.5 | 1.5 | 1.5 | 1.5 | 1.5 | 1.5 | 1.5 | 1.5 |
| pH of polymer | 1.9 | 3.2 | 1.9 | 3.2 | 1.9 | 3.2 | 1.9 | 3.2 | 1.9 | 3.2 | 1.9 | 3.2 | 1.9 | 1.9 | 3.2 | 1.9 | 3.5 |
| before addition | | | | | | | | | | | | | | | | | |
| Stability at RT | S | NS | NS | NS | NS | NS | S | NS | NS | NS | NS | NS | NS | NS | NS | NS | NS |
| Stability at 45° C. | NS | NS | NS | NS | NS | NS | NS | NS | NS | NS | NS | NS | NS | NS | NS | NS | NS |
| Appearance | NC | NC | NC | NC | NC | NC | NC | NC | NC | NC | NC | NC | NC | NC | NC | NC | NC |
| pH of final | 5.7 | 5.8 | 5.4 | 5.6 | 5.2 | 5.4 | 6.9 | 5.6 | 7.0 | 7.0 | 7.0 | 7.0 | 7.0 | 5.6 | 5.6 | 5.6 | 7.0 |
| formulation | | | | | | | | | | | | | | | | | |
| Tenancy to foam | Yes | No | No | No | No | No | No | No | No | No | No | No | No | No | No | No | No |

| | |
|---|---|
| Hard water scale | Not stable hence not checked |
| Removal | |

### Comparative Example Set F: Effect of Adding Controlling Polymers at Neutral pH

Table-7A to 7D (Comparative Examples 48-101), illustrate the formulations wherein controlling polymers were first neutralized to around pH 7 using NaOH and then incorporated into Reference Examples 1 and 2. Water was added to bring the total to 100% by weight. However all the formulations showed strong chelating behavior around pH 7 and precipitated out quickly from the system. Further to increase stability of composition various concentrations of surfactants and organic solvents were tried. None of them were found to be suitable in terms of performance and stability.

TABLE 7A

| | Example No | | | | | | | | | | | | | | | |
|---|---|---|---|---|---|---|---|---|---|---|---|---|---|---|---|---|
| | 48 | 49 | 50 | 51 | 52 | 53 | 54 | 55 | 56 | 57 | 58 | 59 | 60 | 61 | 62 | 63 |
| Reference Examples | Ref-2 | Ref-2 | Ref-2 | Ref-2 | Ref-2 | Ref-2 | Ref-2 | Ref-2 | Ref-2 | Ref-1 | Ref-1 | Ref-1 | Ref-1 | Ref-1 | Ref-1 | Ref-1 |
| Ethylene glycol | 6 | 6 | 6 | — | — | 6 | — | 6 | 15 | 6 | 6 | 6 | — | — | 6 | — |
| Dipropylene glycol | 5 | 5 | — | 5 | 10 | 5 | 15 | 6 | — | 5 | 5 | — | 5 | 10 | 5 | 15 |
| methyl ether | | | | | | | | | | | | | | | | |
| Surf-NI-3 | 5 | — | 5 | 1 | — | 1 | — | 3 | — | 5 | — | 5 | 1 | — | 1 | — |
| Surf-Amp-1 | 7 | 7 | 7 | 12 | 12 | 10 | 8 | 8 | 8 | 7 | 7 | 7 | 12 | 12 | 10 | 8 |
| CP-1 | 2 | 2 | 2 | 2 | 2 | 2 | 2 | 2 | 2 | 2 | 2 | 2 | 2 | 2 | 2 | 2 |
| Surfadone LP 300 | 0.2 | 0.2 | 0.2 | 0.2 | 0.2 | — | — | — | — | 0.2 | 0.2 | 0.2 | 0.2 | 0.2 | — | — |
| Kathon WT | 1.5 | 0.15 | 0.15 | 0.15 | 0.15 | 0.15 | 0.15 | 0.15 | 0.15 | 1.5 | 0.15 | 0.15 | 0.15 | 0.15 | 0.15 | 0.15 |
| pH of polymer before | 7.0 | 7.0 | 7.0 | 7.0 | 7.0 | 7.0 | 7.0 | 7.0 | 7.0 | 7.0 | 7.0 | 7.0 | 7.0 | 7.0 | 7.0 | 7.0 |
| addition | | | | | | | | | | | | | | | | |
| Stability at RT | NS | NS | NS | NS | NS | NS | NS | NS | NS | NS | NS | NS | NS | NS | NS | NS |
| Stability at 45 C. | NS | NS | NS | NS | NS | NS | NS | NS | NS | NS | NS | NS | NS | NS | NS | NS |
| Appearance | NC | NC | NC | NC | NC | NC | NC | NC | NC | NC | NC | NC | NC | NC | NC | NC |
| pH final solution | 6.9-7.1 | | | | | | | | | | | | | | | |
| Tendency to foam | No | No | No | No | No | No | No | No | No | No | No | No | No | No | No | No |
| Scale removal | No | No | No | No | No | No | No | No | No | No | No | No | No | No | No | No |

TABLE 7B

| | Example No | | | | | | | | | | | | | |
|---|---|---|---|---|---|---|---|---|---|---|---|---|---|---|
| | 64 | 65 | 66 | 67 | 68 | 69 | 70 | 71 | 72 | 73 | 74 | 75 | 76 | 77 |
| Reference Examples | Ref-1 | Ref-1 | Ref-2 | Ref-2 | Ref-2 | Ref-2 | Ref-2 | Ref-2 | Ref-2 | Ref-2 | Ref-2 | Ref-1 | Ref-1 | Ref-1 |
| Ethylene glycol | 6 | 15 | 6 | 6 | 6 | | | 6 | | 6 | 15 | 6 | 6 | 6 |
| Dipropylene glycol | 6 | | 5 | 5 | | 5 | 10 | 5 | 15 | 6 | | 5 | 5 | |
| methyl ether | | | | | | | | | | | | | | |
| Surf-NI-3 | 3 | | 5 | | 5 | 1 | | 1 | | 3 | | 5 | | 5 |
| Surf-Amp-1 | 8 | 8 | 7 | 7 | 7 | 12 | 12 | 10 | 8 | 8 | 8 | 7 | 7 | 7 |
| CP-1 | 2 | 2 | | | | | | | | | | | | |
| CP-2 | | | 2 | 2 | 2 | 2 | 2 | 2 | 2 | 2 | 2 | 2 | 2 | 2 |
| Add-2 | | | | | | | 0.2 | | | | | 0.2 | 0.2 | 0.2 |
| Add-3 | 0.15 | 0.15 | 0.15 | 0.15 | 0.15 | 0.15 | 0.15 | 0.15 | 0.15 | 0.15 | 0.15 | 1.5 | 0.15 | 0.15 |
| pH of polymer before | 6.98 | 7 | 7 | 6.98 | 6.98 | 6.96 | 6.98 | 6.98 | 6.99 | 7 | 7 | 7 | 7.02 | 7.03 |
| addition | | | | | | | | | | | | | | |
| Stability at RT | NS | NS | NS | NS | NS | NS | NS | NS | NS | NS | NS | NS | NS | NS |
| Stability at 45 C. | NS | NS | NS | NS | NS | NS | NS | NS | NS | NS | NS | NS | NS | NS |
| Appearance & pH of final | NC | | | | | | | | | | | | | |
| formulation | | | | | | | | | | | | | | |
| pH final solution | 6.9 to 7.1 | | | | | | | | | | | | | |
| Tenancy to foam | No | No | No | No | No | No | No | No | No | No | No | No | No | No |

| | |
|---|---|
| Hard water scale deposits, | Not stable hence not checked |
| rusting and shine | |

TABLE 7C

| | Example No | | | | | | | | | | | | |
|---|---|---|---|---|---|---|---|---|---|---|---|---|---|
| | 78 | 79 | 80 | 81 | 82 | 83 | 84 | 85 | 86 | 87 | 88 | 89 | 90 |
| Reference Examples | Ref-1 | Ref-1 | Ref-1 | Ref-1 | Ref-1 | Ref-2 | Ref-2 | Ref-1 | Ref-1 | Ref-1 | Ref-1 | Ref-1 | Ref-1 |
| Enz-P | 10 | 10 | 10 | 10 | 10 | 10 | 10 | 10 | 10 | 10 | 10 | 10 | 10 |
| Enz-L | 0.22 | 0.22 | 0.22 | 0.22 | 0.22 | 0.22 | 0.22 | 0.22 | 0.22 | 0.22 | 0.22 | 0.22 | 0.22 |
| Enz-C | 0.11 | 0.11 | 0.11 | 0.11 | 0.11 | 0.11 | 0.11 | 0.11 | 0.11 | 0.11 | 0.11 | 0.11 | 0.11 |
| Enz-A | 1.5 | 1.5 | 1.5 | 1.5 | 1.5 | 1.5 | 1.5 | 1.5 | 1.5 | 1.5 | 1.5 | 1.5 | 1.5 |
| water | QS | QS | QS | QS | QS | QS | QS | QS | QS | QS | QS | QS | QS |
| Ethylene glycol | | | 6 | | 6 | | 6 | | | | | | |
| Dipropylene glycol methyl ether | 5 | 10 | 5 | 15 | 6 | | 5 | 7 | 7 | 7 | 7 | 7 | 7 |
| Surf-NI-3 | 1 | | 1 | | 3 | 3 | 1 | 6 | 6 | 6 | 6 | 6 | 6 |
| Surf-Amp-2 | 12 | 12 | 10 | 8 | 8 | 10 | 10 | 12 | 12 | 12 | 12 | | |
| CP-1 | | | | | | 2 | | 2 | | 2 | | 2 | |
| Surf-NI-1 | | | | | | | | | | | | 7 | 7 |
| CP-2 | 2 | 2 | 2 | 2 | 2 | | 2 | | 2 | | 2 | | 2 |
| Add-2 | 0.2 | 0.2 | | | | | | 0.2 | 0.2 | 0.2 | 0.2 | 0.2 | 0.2 |
| Add-3 | 0.15 | 0.15 | 0.15 | 0.15 | 0.15 | 1.5 | 1.5 | 0.15 | 0.15 | 0.15 | 1.5 | 0.15 | 0.15 |
| pH of polymer before addition | 7 | 7 | 6.99 | 6.99 | 7 | 6.97 | 6.98 | 6.98 | 7 | 7.01 | 7.02 | 7 | 7 |
| Stability at RT | NS | NS | NS | NS | NS | NS | NS | NS | NS | NS | NS | NS | NS |
| Stability at 45 C. | NS | NS | NS | NS | NS | NS | NS | NS | NS | NS | NS | NS | NS |
| Tenancy to foam | No | No | No | No | No | No | No | No | No | No | No | No | No |

| | |
|---|---|
| Hard water scale deposits, rusting and | Not stable hence not checked |
| shine | |

TABLE 7D

| | Example No | | | | | | | | | | |
|---|---|---|---|---|---|---|---|---|---|---|---|
| | 91 | 92 | 93 | 94 | 95 | 96 | 97 | 98 | 99 | 100 | 101 |
| Borax | 2 | 2 | 2 | 2 | — | — | — | — | — | — | — |
| Glycerol | 4 | 4 | 4 | 4 | — | — | — | — | — | — | — |
| Reference Examples | — | — | — | — | Ref-2 | Ref-2 | Ref-2 | Ref-2 | Ref-2 | Ref-2 | Ref-2 |
| Enz-P | 10 | 10 | 10 | 10 | 10 | 10 | 10 | 10 | 10 | 10 | 10 |
| Enz-L | 0.22 | 0.22 | 0.22 | 0.22 | 0.22 | 0.22 | 0.22 | 0.22 | 0.22 | 0.22 | 0.22 |
| Enz-C | 0.11 | 0.11 | 0.11 | 0.11 | 0.11 | 0.11 | 0.11 | 0.11 | 0.11 | 0.11 | 0.11 |
| Enz-A | 1.5 | 1.5 | 1.5 | 1.5 | 1.5 | 1.5 | 1.5 | 1.5 | 1.5 | 1.5 | 1.5 |
| water | QS | QS | QS | QS | QS | QS | QS | QS | QS | QS | QS |
| Surf-NI-3 | 1 | 1 | 1 | 1 | | | | | | | |
| Surf-I-1 | 7 | 7 | 7 | 7 | 7 | 7 | 7 | 7 | 7 | 7 | 7 |
| Surf-Amp-1 | | | | | | | | | 6 | 6 | 6 |
| Surf-NI-4 | 5.5 | 5.5 | 5.5 | 5.5 | 6 | 6 | 6 | 6 | | | |
| CP-1 | 2 | | 2 | | 2 | | 2 | | 2 | | 2 |
| CP-2 | | 2 | | 2 | | 2 | | 2 | | 2 | |
| Add-2 | 0.33 | 0.33 | 0.33 | 0.33 | | | | | | | |
| Add-3 | 1.5 | 1.5 | 1.5 | 1.5 | 1.5 | 1.5 | 1.5 | 1.5 | 1.5 | 1.5 | 1.5 |
| pH of polymer before addition | 7 | 7 | 7.01 | 7.01 | 7.01 | 7 | 7 | 7 | 7 | 7 | 7 |
| Stability at RT | NS | NS | NS | NS | NS | NS | NS | NS | NS | NS | NS |
| Stability at 45 C. | NS | NS | NS | NS | NS | NS | NS | NS | NS | NS | NS |
| Appearance | NC | | | | | | | | | | |
| pH of final formulation | 6.9 to 7.1 | | | | | | | | | | |
| Tenancy to foam | No | No | No | No | No | No | No | No | No | No | No |

| | |
|---|---|
| Hard water scale deposits, | Not stable hence not checked |
| rusting and shine | |

### Comparative Example-G: Effect of Adding Controlling Polymers at Basic pH

Table 8A-8D (examples 102-137), illustrate the formulations wherein controlling polymers are first neutralized around 12 to 12.5 using NaOH and then incorporated in the formulations. This approach shows stable formulations. Examples 102-106 turned to a dark color after aging at 45° C., however they remained clear hence tests evaluating their inhibition of hard water scale deposition was carried out. Examples 103-105 and 107 showed acceptable results for inhibition of hard water scale deposition. Overall PM 200 (at pH 12 to 12.5) and plasdone K29 (at pH 7) showed good stability and inhibition of scale deposition behavior. Maxinol 5420 (at pH 12 to 12.5) was precipitated out after 20 days aging at 45° C. Examples 109-137 showed acceptable stability with no foaming and inhibition for hard scale deposition. Overall Example No 129, 130 and 134 were found best for the blood removal test and hence were considered for the next level of optimization for surfactants and organic solvents.

TABLE 8A

| | Example No | | | | | | | | | | | | |
|---|---|---|---|---|---|---|---|---|---|---|---|---|---|
| | 102 | 103 | 104 | 105 | 106 | 107 | 108 | 109 | 110 | 111 | 112 | 113 | 114 |
| Borax | 3 | 2 | 2 | 2 | 2 | 2 | 2 | 2 | 2 | 2 | 2 | 2 | 2 |
| Glycerol | — | 4 | — | 4 | 4 | — | — | — | — | — | 4 | — | 4 |
| DC 2501 | 1 | — | 1 | — | — | 1 | 1 | 1 | 1 | 1 | — | 1 | — |
| Enz-P | 10 | 10 | 10 | 10 | 10 | 10 | 10 | 10 | 10 | 10 | 10 | 10 | 10 |
| Enz-L | 0.22 | 0.22 | 0.22 | 0.22 | 0.22 | 0.22 | 0.22 | 0.22 | 0.22 | 0.22 | 0.22 | 0.22 | 0.22 |
| Enz-C | 0.11 | 0.11 | 0.11 | 0.11 | 0.11 | 0.11 | 0.11 | 0.11 | 0.11 | 0.11 | 0.11 | 0.11 | 0.11 |
| Enz-A | 1.5 | 1.5 | 1.5 | 1.5 | 1.5 | 1.5 | 1.5 | 1.5 | 1.5 | 1.5 | 1.5 | 1.5 | 1.5 |
| Water | QS | QS | QS | QS | QS | QS | QS | QS | QS | QS | QS | QS | QS |
| Surf-NI-3 | | | | 1 | 1 | | | | | | | | 1 |
| Surf-I-1 | 7 | 7 | 7 | 7 | 7 | 7 | 7 | 7 | 7 | 7 | 7 | 7 | 7 |
| Surf-Amp-1 | 6 | 6 | 6 | 5.5 | 5.5 | | | 7 | 10 | 10 | 10 | 10 | 6 |
| Surf-NI-1 | | | | | | 7 | 7 | | | | | | |
| CP-1 | | | | 2 | | 2 | | 2 | | 2 | | | 2 |
| CP-2 | 2 | | | | 2 | | 2 | | 2 | | | | |
| CP-3 | | 2 | 2 | | | | | | | | 2 | 2 | |
| Add-1 | | 0.5 | 0.5 | | | | | | | | 0.5 | 0.5 | |
| Add-2 | | | | 0.33 | 0.33 | | | | | | | | 0.03 |
| Add-3 | 1.5 | 1.5 | 1.5 | 1.5 | 1.5 | 1.5 | 1.5 | 1.5 | 1.5 | 1.5 | 1.5 | 1.5 | 1.5 |
| pH of polymer | 12-12.5 | | | 12 to | 12 to | 12 to | 12 to | 12 to | 12 to | 12 to | | | 12 to |
| before addition | | | | 12.5 | 12.5 | 12.5 | 12.5 | 12.5 | 12.5 | 12.5 | | | 12.5 |
| Stability at RT | S | S | S | S | S | S | S | S | S | S | S | S | S |
| Stability at 45° C. | S | S | S | S | S | S | S | S | NS | S | S | S | S |
| Appearance | C, dark | C, dark | C, dark | C, | C, | C, | C, | C | NS | S | S | S | S |
| | color | color | color | dark | dark | dark | dark | | | | | | |
| | | | | color | color, | color | color | | | | | | |
| pH of final | 6.83 | 7.1 | 6.66 | 7.09 | 7.1 | 6.92 | 6.82 | 6.88 | 7.07 | 7.07 | 7.04 | 7.06 | 7.05 |
| formulation | | | | | | | | | | | | | |
| Tenancy to foam | No | No | No | No | No | No | No | No | No | No | No | No | No |
| Hard water scale | No | Yes | Yes | Yes | No | Yes | No | Yes | No | Yes | No | No | No |
| deposits, rusting | | | | | | | | | | | | | |
| and shine | | | | | | | | | | | | | |

| | | | | | | | |
|---|---|---|---|---|---|---|---|
| Enzyme | Not checked due to color change | 14 min | — | 16 min | 12 min | 12 min | 15 min |
| activity/blood strip | | | | | | | |
| test | | | | | | | |

TABLE 8B

| | Example No | | | | | | | | | | | |
|---|---|---|---|---|---|---|---|---|---|---|---|---|
| | 115 | 116 | 117 | 118 | 119 | 120 | 121 | 122 | 123 | 124 | 125 | 126 |
| Borax | 2 | 3 | 2 | 2 | 2 | 2 | 2 | 2 | 2 | 2 | 2 | 2 |
| Glycerol | 4 | | 4 | | | | 4 | 4 | 4 | 4 | 4 | |
| DC 2501 | | 1 | | 1 | 1 | 1 | | | | | | 1 |
| Enz-P | 10 | 10 | 10 | 10 | 10 | 10 | 10 | 10 | 10 | 10 | 10 | 10 |
| Enz-L | 0.22 | 0.22 | 0.22 | 0.22 | 0.22 | 0.22 | 0.22 | 0.22 | 0.22 | 0.22 | 0.22 | 0.22 |
| Enz-C | 0.11 | 0.11 | 0.11 | 0.11 | 0.11 | 0.11 | 0.11 | 0.11 | 0.11 | 0.11 | 0.11 | 0.11 |
| Enz-A | 1.5 | 1.5 | 1.5 | 1.5 | 1.5 | 1.5 | 1.5 | 1.5 | 1.5 | 1.5 | 1.5 | 1.5 |
| water | QS | QS | QS | QS | QS | QS | QS | QS | QS | QS | QS | QS |
| Ethylene glycol | | | | 10 | | | 10 | | | 10 | | |
| Dipropylene glycol methyl | | | | | 10 | | | 10 | | | 10 | |
| ether | | | | | | | | | | | | |
| Surf-NI-3 | 1 | | 1 | | | 10 | | | 10 | | | 10 |
| Surf-I-1 | 7 | 7 | 7 | 7 | 7 | 7 | 7 | 7 | 7 | 7 | 7 | 7 |
| Surf-Amp-1 | 6 | 5.5 | 5.5 | 10 | 10 | 10 | 6 | 6 | 6 | 10 | 10 | 10 |
| CP-1 | | | | 2 | 2 | 2 | 2 | 2 | 2 | | | |
| CP-2 | 2 | 2 | 2 | | | | | | | | | |
| CP-3 | | | | | | | | | | 2 | 2 | 2 |
| Add-1 | | | | | | | | | | 0.5 | 0.5 | 0.5 |
| Add-2 | 0.03 | | 0.03 | | | | 0.03 | 0.03 | 0.03 | | | |
| Add-3 | 1.5 | 1.5 | 1.5 | 1.5 | 1.5 | 1.5 | 1.5 | 1.5 | 1.5 | 1.5 | 1.5 | 1.5 |
| pH of polymer before | 12 to | 12 to | 12 to | 12 to | 12 to | 12 to | 12 to | 12 to | 12 to | 12 to | | |
| addition | 12.5 | 12.5 | 12.5 | 12.5 | 12.5 | 12.5 | 12.5 | 12.5 | 12.5 | 12.5 | | |
| Stability at RT | S | S | S | S | S | S | S | S | S | S | S | S |
| Stability at 45 C. | NS | NS | NS | S | NS | S | S | S* | S* | S* | S* | S* |
| Appearance | NS | NS | NS | S | S | S | S | C | C | NC | NC | C |
| pH of final formulation | 7.05 | 7.04 | 7 | 7.05 | 7.05 | 7.05 | 7.03 | 7.02 | 7.02 | 7.05 | 7.04 | 7.05 |
| Tenancy to foam | No | No | No | No | No | No | No | No | No | No | No | No |
| Hard water scale deposits, | No | No | Yes | Yes | Yes | Yes | Yes | Yes | Yes | No | No | Yes |
| rusting and shine | | | | | | | | | | | | |
| Enzyme activity/Blood strip | — | — | — | 15 min | — | 16 min | 16 min | 16 min | 18 min | — | — | 16 min |
| test | | | | | | | | | | | | |

S* = Stable at 52° C.

TABLE 8C

| | Example No | | | | | | | | | | |
|---|---|---|---|---|---|---|---|---|---|---|---|
| | 127 | 128 | 129 | 130 | 131 | 132 | 133 | 134 | 135 | 136 | 137 |
| Borax | | | 3 | 3 | 3 | | 3 | 3 | 3 | 3 | 3 |
| Glycerol | | | 10 | 6 | 4 | | 6 | 10 | 6 | 10 | 10 |
| Reference Examples | Ref-2 | Ref-2 | | | | Ref-2 | 1 | | | | |
| Enz-P | 10 | 10 | 10 | 10 | 10 | 10 | 10 | 10 | 10 | 10 | 10 |
| Enz-L | 0.22 | 0.22 | 0.22 | 0.22 | 0.22 | 0.22 | 0.22 | 0.22 | 0.22 | 0.22 | 0.22 |
| Enz-C | 0.11 | 0.11 | 0.11 | 0.11 | 0.11 | 0.11 | 0.11 | 0.11 | 0.11 | 0.11 | 0.11 |
| Enz-A | 1.5 | 1.5 | 1.5 | 1.5 | 1.5 | 1.5 | 1.5 | 1.5 | 1.5 | 1.5 | 1.5 |
| water | QS | QS | QS | QS | QS | QS | QS | QS | QS | QS | QS |
| Ethylene glycol | | 3 | | | 6 | 5 | 5 | | | | 3 |
| Dipropylene glycol methyl ether | | | | | 10 | | | | | | 3 |
| Surf-NI-3 | 3 | 5 | 5 | 3 | 7 | 5 | 5 | 7 | 3 | 10 | 10 |
| Surf-I-1 | 7 | 7 | 7 | 7 | 5 | 7 | 7 | 7 | 7 | 7 | 7 |
| Surf-Amp-1 | 8 | 8 | 6 | 6 | 10 | 8 | 8 | 8 | 8 | 10 | 10 |
| CP-1 | 2 | 2 | 2 | 2 | | 2 | 2 | 2 | 2 | | |
| CP-3 | | | | | 2 | | | | | 2 | 2 |
| Add-1 | | | | | 0.5 | | | | | 0.5 | 0.5 |
| Add-2 | | | 0.03 | 0.03 | 0.03 | | | 0.03 | 0.03 | 0.03 | 0.03 |
| Add-3 | 1.5 | 1.5 | 1.5 | 1.5 | 1.5 | 1.5 | 1.5 | 1.5 | 1.5 | 1.5 | 1.5 |
| pH of polymer before addition | 12 to | 12 to | 12 to | 12 to | 12 to | 12 to | 12 to | 12 to | 12 to | 12 to | 12 to |
| | 12.5 | 12.5 | 12.5 | 12.5 | 12.5 | 12.5 | 12.5 | 12.5 | 12.5 | 12.5 | 12.5 |
| Stability at RT | S | S | S | S | S | S | S | S | S | S | S |
| Stability at 52° C. | S | S | S | S | NS | S | S | S | S | S | S |
| Appearance | C | C | C | C | NC | C | C | C | C | C | NC |
| pH of final formulation | 7.04 | 7 | 7 | 7.03 | 7 | 6.89 | 7.04 | 7.08 | 7.12 | 7.05 | 7.23 |
| Tenancy to foam | No | No | No | No | No | No | No | No | No | No | No |
| Hard water scale deposits, | Yes | Yes | Yes | Yes | | Yes | Yes | Yes | Yes | Yes | No |
| rusting and shine | | | | | | | | | | | |
| Enzyme activity/Blood strip | 18 min | 17 mn | 9 min | 11 min | — | 20 min | 12 min | 10 min | 15 min | 26 min | 23 min |
| test* | | | | | | | | | | | |

### Comparative Example-H: Effect of Controlling Polymers with Various Surfactants and Organic Solvent

Table-9 (Example No 138-148), illustrate the formulations where combinations of controlling polymers (i.e. PM 200 (at pH 12 to 12.5) and Plasdone K 29 (at pH 7)) were tried with various surfactants and organic solvent combinations to have optimum performance. Example No 138, 139, 142-148 showed excellent results for enzymatic cleaning, inhibition for hard water scale and rusting, dull shine, less foaming and multi enzyme protection. Example 138-148 shows good storage stability with acceptable other physical parameters. Overall examples Nos. 146 to 148 are the most promising compositions since they exhibit all desired properties.

TABLE 9

| | | Example No | | | | | |
|---|---|---|---|---|---|---|---|
| | Desired value | 138 | 139 | 140 | 141 | 142 | 143 |
| Reference | | Ref-2 | Ref-2 | Ref-2 | Ref-2 | Ref-1 | 3 |
| Examples | | | | | | | |
| Glycerol | | 6 | 6 | 6 | 6 | 7 | |
| Enz-P | | 10 | 10 | 10 | 10 | 10 | 10 |
| Enz-L | | 0.22 | 0.22 | 0.22 | 0.22 | 0.22 | 0.22 |
| Enz-C | | 0.11 | 0.11 | 0.11 | 0.11 | 0.11 | 0.11 |
| Enz-A | | 1.5 | 1.5 | 1.5 | 1.5 | 1.5 | 1.5 |
| water | | QS | QS | QS | QS | QS | QS |
| Ethylene | | 5 | 5 | | | | 5 |
| glycol | | | | | | | |
| Surf-NI-3 | | 3 | 3 | 3 | 3 | 3 | 3 |
| Surf-I-1 | | 7 | 7 | 7 | 7 | 7 | 7 |
| Surf-Amp-1 | | 8 | 8 | 8 | 8 | 8 | 8 |
| CP-1 | | 1 | 1 | 1 | 1 | 1 | 1 |
| CP-3 | | 1 | 1 | 1 | 1 | 1 | 1 |
| Add-1 | | 0.25 | 0.5 | 0.5 | 0.5 | 0.5 | 0.5 |
| Add-2 | | 0.03 | 0.2 | 0.2 | 0.03 | 0.03 | 0.03 |
| Add-3 | | 1.5 | 1.5 | 1.5 | 1.5 | 1.5 | 1.5 |
| pH of | | PM 200- | PM 200- | PM 200- | 12 to | PM 200- | PM 200- |
| polymer | | 12 to | 12 to | 12 to | 12.5 | 12 to | 12 to |
| before | | 12.5 | 12.5 | 12.5 | | 12.5 | 12.5 |
| addition | | | | | | | |
| Stability at | S | S | S | S | S | S | S |
| RT | | | | | | | |
| Stability at | S | S | S | S | S | S | S |
| 52 C. | | | | | | | |
| Appearance | C | C | C | C | C | C | C |
| pH of final | 6.9 to 7.1 | 7 | 7.01 | 6.9 | 6.96 | 6.98 | 7.02 |
| formulation | | | | | | | |
| Tenancy to | No | No | No | No | No | No | No |
| foam | | | | | | | |
| Hard water | Yes | Yes | Yes | Yes | Yes | Yes | Yes |
| scale | | | | | | | |
| deposits, | | | | | | | |
| rusting and | | | | | | | |
| shine | | | | | | | |
| Enzyme | Protease - | Protease | Protease | Protease | Protease | Protease | Protease |
| activity/ | NLT | 0.28 AU/ml & | 0.37 AU/ml & | 0.1 AU/ml & | 0.19 AU/ml & | 0.371 AU/ml & | 0.27 AU/ml & |
| Blood strip | 0.25 AU/ml & | Amylase | Amylase | Amylase | Amylase | Amylase | Amylase |
| test | Amylase - | 3.8 KNU/ml, | 3.68 KNU/ml, | 3.03 KNU/ml, | 3.43 KNU/ml, | 3.46 KNU/ml, | 3.4 KNU/ml, |
| | NLT | 12 min | 11 min | 18 min | 14 min | 8 min | 13 min |
| | 3.0 KNU/ml. | | | | | | |
| | 8 to 12 min | | | | | | |

| | | Example No | | | | |
|---|---|---|---|---|---|---|
| | Desired value | 144 | 145 | 146 | 147 | 148 |
| Reference | | Ref-2 | Ref-2 | Ref-2 | Ref-2 | Ref-2 |
| Examples | | | | | | |
| Glycerol | | | 6 | 6 | 6 | 10 |
| Enz-P | | 10 | 7 | 7 | 7 | 7 |
| Enz-L | | 0.22 | 0.1 | 0.1 | 0.1 | 0.1 |
| Enz-C | | 0.11 | 0.07 | 0.07 | 0.07 | 0.07 |
| Enz-A | | 1.5 | 3.1 | 3.1 | 3.1 | 3.1 |
| water | | QS | QS | QS | QS | QS |
| Ethylene | | 5 | 3 | 1 | 5 | |
| glycol | | | | | | |
| Surf-NI-3 | | 3 | 3 | 3 | 3 | 3 |
| Surf-I-1 | | 7 | 7 | 7 | 7 | 7 |
| Surf-Amp-1 | | 8 | 8 | 8 | 8 | 8 |
| CP-1 | | 1 | 1 | 1 | 1 | 1 |
| CP-3 | | 1 | 1 | 1 | 1 | 1 |
| Add-1 | | 0.5 | 0.25 | 0.25 | | |
| Add-2 | | 0.2 | 0.03 | 0.03 | 0.03 | 0.03 |
| Add-3 | | 1.5 | 1.5 | 1.5 | 1.5 | 1.5 |
| pH of | | PM 200- | PM 200- | PM 200- | PM 200- | PM 200- |
| polymer | | 12 to | 12 to | 12 to | 12 to | 12 to |
| before | | 12.5 | 12.5 | 12.5 | 12.5 | 12.5 |
| addition | | | | | | |
| Stability at | S | S | S | S | S | S |
| RT | | | | | | |
| Stability at | S | S | S | S | S | S |
| 52 C. | | | | | | |
| Appearance | C | C | C | C | C | C |
| pH of final | 6.9 to 7.1 | 7.03 | 7.03 | 7.03 | 7.03 | 7.03 |
| formulation | | | | | | |
| Tenancy to | No | No | No | No | No | No |
| foam | | | | | | |
| Hard water | Yes | Yes | Yes | Yes | Yes | Yes |
| scale | | | | | | |
| deposits, | | | | | | |
| rusting and | | | | | | |
| shine | | | | | | |
| Enzyme | Protease - | Protease | Protease | Protease | Protease | Protease |
| activity/ | NLT | 0.30 AU/ml & | 0.281 AU/ml & | 0.280 AU/ml & | 0.284 AU/ml & | 0.294 AU/ml & |
| Blood strip | 0.25 AU/ml & | Amylase | Amylase | Amylase | Amylase | Amylase |
| test | Amylase - | 3.75 KNU/ml, | 6.5 KNU/ml, | 4.5 KNU/ml, | 7 KNU/ml, | 3.06 KNU/ml, |
| | NLT | 13 min | 9 min | 9 min | 9 min | 9 min |
| | 3.0 KNU/ml. | | | | | |
| | 8 to 12 min | | | | | |

### Example-I: Comparison of the Performance of the Compositions of the Present Disclosure with Other Commercially Available Products

Table-10 illustrates the comparison of performance of hard water scale cleaning on stainless steel plates of example 146, with known commercially available samples (CIDEZYME xtra from J & J, NEODISHER from Dr. Weigert, an alkaline cleaner and RMEC 70500). Example 146 was found to provide excellent results for hard water scale inhibition and rusting with shine.

TABLE 10

| | | Blood removal time | Protease | Amylase | Tenancy to | Hard water scale | | |
|---|---|---|---|---|---|---|---|---|
| Sample | Dilution | and pH | AU · ml | KNU/ml | foam | deposits* | Rusting* | Shine* |
| Market sample 1 | 1:100 | 12.14, | — | — | No | 1 | 1 | 1 |
| | | more than 14 min | | | | | | |
| Market sample 2 | 1:100 | 8.32, | 0.083 | 3.03 | No | 3 | 4 | 4 |
| | | 11 to 12 min | | | | | | |
| Market sample 3 | 1:100 | 6.8, | 0.451 | 3.8 | Yes | 4 | 4 | 4 |
| | | 9 to 10 min | | | | | | |
| Example No. 146 | 1:100 | 6.85, | 0.28 | 4.5 | No | 9 | 9 | 9 |
| of the present | | 9 min | | | | | | |
| invention | | | | | | | | |

*Where 1 = least and 9 = Excellent.

It will be apparent from the foregoing that many other variations and modifications may be made regarding the cleaning compositions described herein, without departing substantially from the essential features, concepts and spirit of the present invention. Accordingly, it should be clearly understood that the forms of the inventions described herein are exemplary only and are not intended as limitations on the scope of the present invention as defined in the appended claims.

1. A cleaning composition comprising:
a. an enzyme activity protector complex comprising a boron compound;
b. an enzyme system;
c. a controlling polymer comprising a plurality of metal ion complexing groups, the complexing groups selected from the group consisting of carboxylic acid groups, pyrrolidone groups, and combinations thereof;
d. at least two surfactants, wherein at least one surfactant is an ionic surfactant and at least one surfactant is an amphoteric surfactant;
e. organic solvent; and
f. water.

2. The cleaning composition as claimed in claim 1 wherein the enzyme activity protector complex is present in an amount of about 2 to about 8% by weight of the composition.

3. The cleaning composition as claimed in claim 1 wherein the enzyme activity protector complex comprises a boron compound and an alkyl ether terminated silane polyether having the formula: 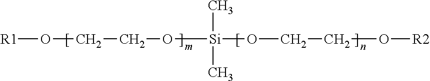
wherein m and n are independently selected integers and range from 8 to 30, and R1 and R2 are linear or branched alkyl groups having 1 to 6 carbon atoms.

4. The cleaning composition as claimed in claim 3 wherein R1 and R2 are methyl groups.

5. The cleaning composition as claimed in claim 3 wherein m and n are at least 12 and no greater than 24.

6. The cleaning composition as claimed in claim 5 wherein m and n are 18.

7. The cleaning composition as claimed in claim 1 wherein the enzyme activity protector complex comprises a boron compound and a polyhydroxy containing compound.

8. The cleaning composition as claimed in claim 7 wherein said polyhydroxy compound is selected from the group consisting of sugars, sugar alcohols, sugar acids, glycerol, and uronic acid, and combinations thereof.

9. The cleaning composition as claimed in claim 7, wherein the boron compound is selected from the group consisting of borax, boric acid and combinations thereof.

10. The cleaning composition as claimed in claim 3, wherein the molar ratio of the boron compound to the silane polyether is from 90:10 to 30:70.

11. The cleaning composition as claimed in claim 10, wherein the molar ratio of the boron compound to the silane polyether is from 70:30 to 40:60.

12. The cleaning composition as claimed in claim 7, wherein the molar ratio of the boron compound to the polyhydroxy compound is from 80:20 to 30:70.

13. The cleaning composition as claimed in claim 12, wherein the molar ratio of the boron compound to the polyhydroxy compound is from 60:40 to 40:60.

14. The cleaning composition as claimed in claim 1, wherein said enzyme system is present in an amount of about 0.5% to about 15% by weight of the total composition.

15. The cleaning composition as claimed in claim 1, wherein the enzyme system comprises enzymes selected from amylases, cellulases, lipases, proteases, and combinations thereof.

16. The cleaning composition as claimed in claim 1, wherein the controlling polymer is present in an amount of about 0.5% to about 10% by weight of the total composition.

17. The cleaning composition as claimed in claim 1, wherein the controlling polymer comprises pyrrolidone groups based on vinyl pyrrolidone.

18. The cleaning composition as claimed in claim 1 wherein the organic solvent is a water soluble organic solvent.

19. The cleaning composition as claimed in claim 18 wherein the organic solvent is selected from the group consisting of ethylene glycol, dipropylene glycol methyl ether, and combination thereof.

20. The cleaning composition as claimed in claim 1, wherein the pH of the composition increases by at least 1 upon dilution with 300 parts water per 1 part of the composition.

21-38. (canceled)
